(19) United States
(12) Patent Application Publication
(10) Pub. No.: US 2026/0261185 A1
(43) Pub. Date: Sep. 3, 2026

(54) ROTOR AND FAN ASSEMBLY WITH AN EMBEDDED MAGNET

(71) Applicant: MILWAUKEE ELECTRIC TOOL CORPORATION, Brookfield, WI (US)

(72) Inventors: Kentez L. Craig, Milwaukee, WI (US); Amith J. Baskaran, Menomonee Falls, WI (US); Andrew R. Palm, Glendale, WI (US)

(21) Appl. No.: 18/879,835

(22) PCT Filed: Jun. 28, 2023
(86) PCT No.: PCT/US2023/026410

§ 371 Date: Dec. 30, 2024

Related U.S. Application Data
(60) Provisional application No. 63/356,742, filed on Jun. 29, 2022.

(51) Int. Cl. H02K 7/14; B25B 21/02; H02K 1/276; H02K 9/06

(52) U.S. Cl. CPC H02K 7/145; B25B 21/02; H02K 1/276; H02K 9/06; H02K 2213/03

(57) ABSTRACT

A power tool is disclosed and includes a housing, a motor within the housing, a rotor and fan assembly within the motor. The rotor and fan assembly includes a rotor with a plurality of magnets, each magnet having an overlap portion that extends beyond a face of the rotor, and a fan adjacent the face of the rotor. The fan includes a plurality of magnet pockets, and the overlap portion of each magnet extends into a respective magnet pocket of the plurality of magnet pockets.

### CROSS-REFERENCE TO RELATED APPLICATIONS

This application claims priority to co-pending U.S. Provisional Patent Application No. 63/356,742 filed on Jun. 29, 2022, the entire content of which is incorporated herein by reference.

### FIELD OF THE INVENTION

The present invention relates to power tools, and more specifically to impact tools.

### BACKGROUND OF THE INVENTION

Impact tools, such as impact drivers and impact wrenches, are typically utilized to provide a striking rotational force, or intermittent applications of torque, to a tool element or workpiece (e.g., a fastener) to either tighten or loosen the fastener.

### SUMMARY OF THE INVENTION

The present invention provides, in one aspect, a power tool that includes a housing, a motor within the housing, a rotor and fan assembly within the motor. The rotor and fan assembly includes a rotor with a plurality of magnets, each magnet having an overlap portion that extends beyond a face of the rotor, and a fan adjacent the face of the rotor. The fan includes a plurality of magnet pockets, and the overlap portion of each magnet extends into a respective magnet pocket of the plurality of magnet pockets.

The present invention provides, in another aspect, a power tool that includes a housing, a motor supported within the housing, the motor including a stator and a rotor, the rotor including a plurality of permanent magnets each having an overlap portion extending beyond a face of the rotor, and a fan coupled to the rotor for rotation therewith relative to the stator, the fan including a disc-shaped base plate, a central hub extending therefrom, and a plurality of magnet pockets extending into the central hub, wherein each magnet pocket receives a respective overlap portion of each of the permanent magnets.

The present invention provides, in still another aspect, a power tool that includes a housing, a motor supported within the housing, the motor including a stator and a rotor, the rotor including a plurality of metal layers laminated together, a plurality of magnet pockets extending perpendicularly through the plurality of metal layers, and a permanent magnet disposed within each of the plurality of magnet pockets, wherein each permanent magnet includes an overlap portion that extends beyond a face of the rotor, and a fan coupled to the rotor for rotation therewith relative to the stator, the fan including a plurality of magnet pockets and the overlap portion of each permanent magnet extends into one of the plurality of magnet pockets.

Other features and aspects of the invention will become apparent by consideration of the following detailed description and accompanying drawings.

### BRIEF DESCRIPTION OF THE DRAWINGS

FIG. 1 is a perspective view of an impact tool according to one embodiment.

FIG. 2 is a front view of the impact tool of FIG. 1.

FIG. 3 is a side view of the impact tool of FIG. 1.

FIG. 4 is a cross-sectional view of the impact tool of FIG. 1, taken along line 4-4 in FIG. 2.

FIG. 5 is a cross-sectional view of the impact tool of FIG. 1, taken along line 5-5 in FIG. 3.

FIG. 6 is a perspective view of a rotor and fan assembly for the impact tool of claim 1.

FIG. 7 is a side plan view of the rotor and fan assembly of FIG. 6.

FIG. 8 is a cross-sectional view of the rotor and fan assembly of FIG. 6.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

As described in greater detail below, the present disclosure provides, in some aspects, a power tool including a motor with a rotor and fan assembly. The rotor and fan assembly includes a rotor with a plurality of magnets, and a fan adjacent the rotor. Portions of the magnets are accommodated within magnet pockets formed in the fan. As such, the overall length of the rotor and fan assembly may be reduced when compared with a typical motor.

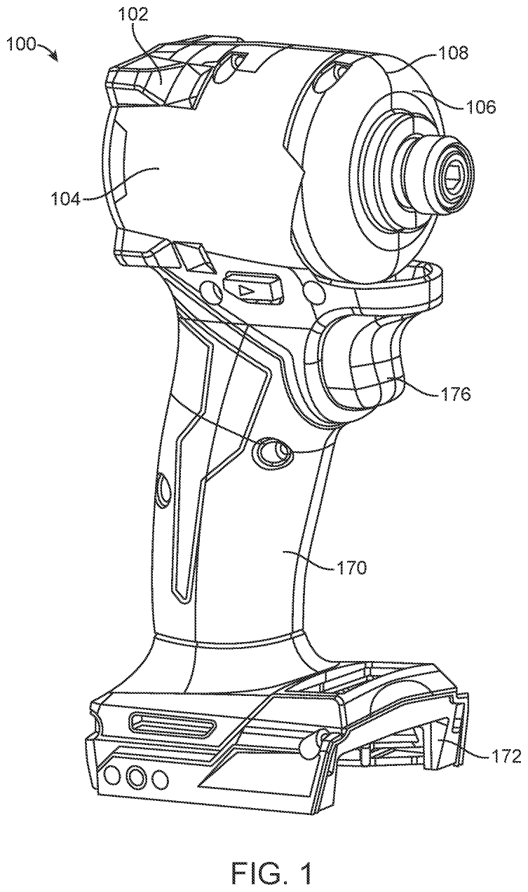

Referring to FIG. 1-FIG. 5, a power tool is illustrated and is generally designated 100. As shown, the power tool is a rotary impact tool 100 (i.e. an impact driver). Specifically, the power tool is a battery powered rotary impact tool 100. As illustrated in FIG. 1, the rotary impact tool 100 includes a housing 102 that has a first housing side 104 and a second housing side 106. As shown in FIG. 1, the housing sides 104, 106 meet to form an interface 108 between the housing sides 104, 106. It is to be understood that the housing sides 104, 106 are cooperating clamshell halves that are attached, or otherwise affixed, to each other via a plurality of fasteners 110, e.g., screws. Alternatively, the housing sides 104, 106 are affixed to each other via an adhesive, via a plastic welding operation, or in any other suitable manner.

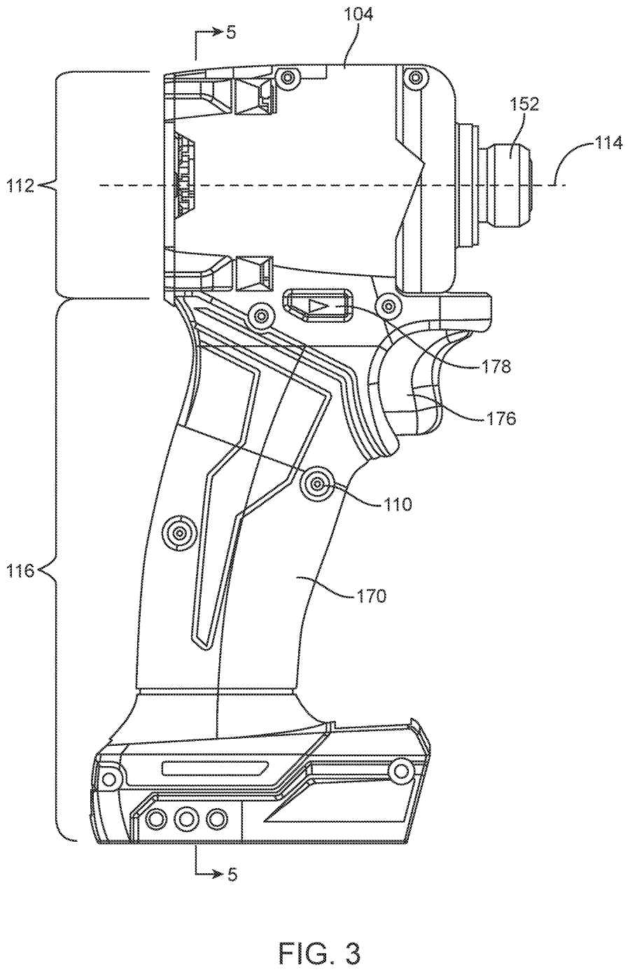

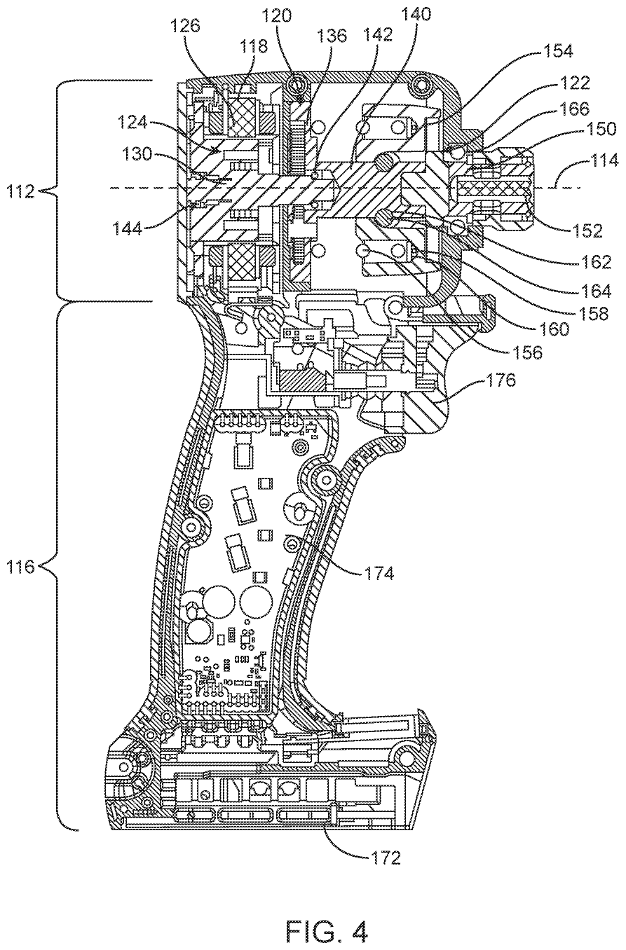

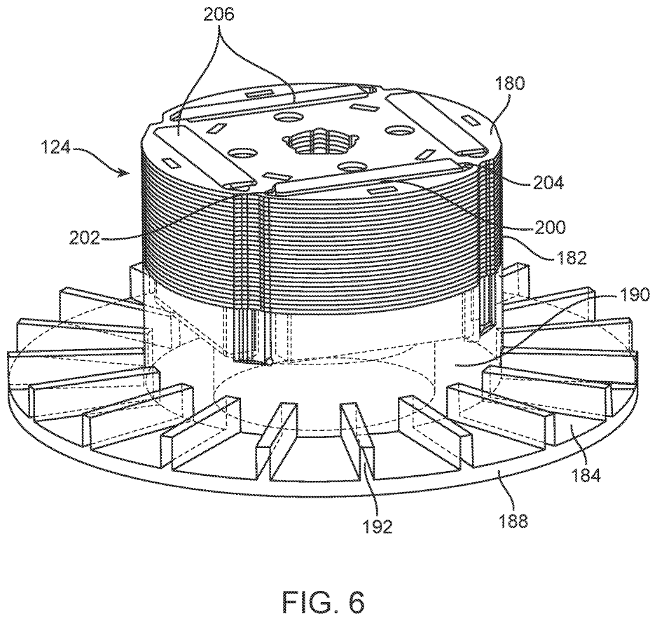

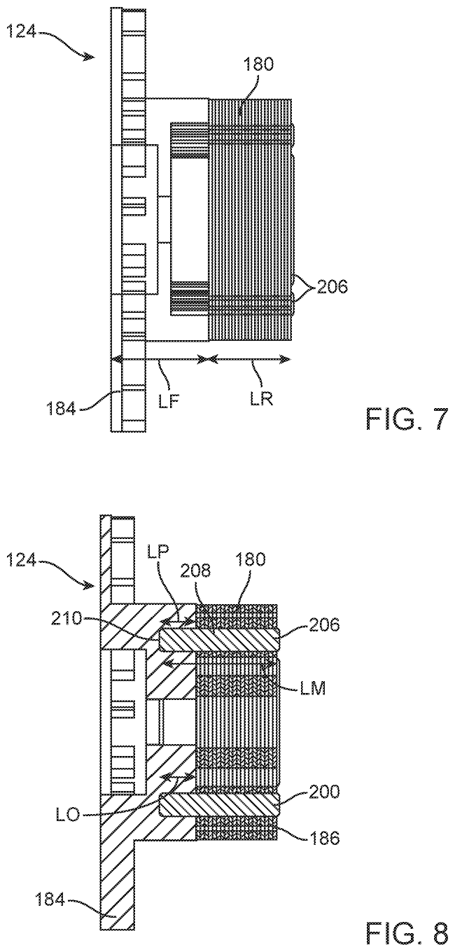

As depicted in FIGS. 3-4, the housing 102 includes a drive portion 112 that defines a drive axis 114. The housing 102 also include a handle portion 116 that extends in a generally perpendicular direction from the drive axis 114. The drive portion 112 of the housing 102 includes a motor 118 operatively coupled to a gear assembly 120 (FIG. 4). The gear assembly 120 is operatively coupled to a drive assembly 122. The illustrated motor 118 is a brushless direct current (“BLDC”) motor having a rotor and fan assembly 124 partially disposed within a stator 126. The motor 118 further includes an output shaft 130 coupled with the rotor and fan assembly 124 and rotates therewith. The rotor and fan assembly 124 is described in greater detail below in conjunction with FIGS. 6-8.

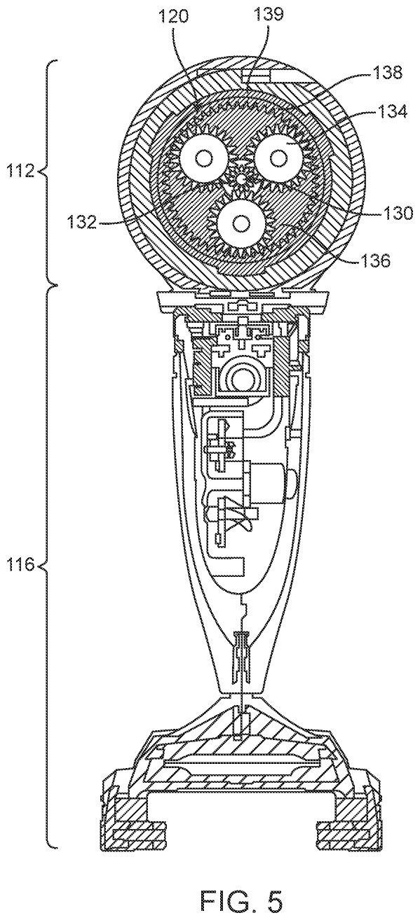

As shown in FIG. 5, the illustrated gear assembly 120 includes a sun gear 132 disposed on the output shaft 130 of the motor 118. A plurality of planet gears 134 is meshed with the sun gear 132 and are disposed on a gear carrier 136. An outer ring gear 138 surrounds the planet gears 134 and is meshed with the planet gears 134. The outer ring gear 138 is fixed within the drive portion 112 of the housing 102 and does not rotate. Accordingly, as the sun gear 132 rotates in one direction, the planet gears 134 rotate in the opposite direction and orbit about the inner periphery of the outer ring gear 138, thereby causing the gear carrier 136 to rotate at a reduced speed. Thus, the gear assembly 120 provides a speed reduction and torque increase from the sun gear 132 to the gear carrier 136.

With reference to FIG. 4, the illustrated drive assembly 122 includes a camshaft 140, and the gear carrier 136 is formed on an end of the camshaft 140. Accordingly, rotation of the output shaft 130 rotates the planet gears 134, which orbit along the inner circumference of the outer ring gear 138 to rotate the camshaft 140. The gear assembly 120 thus provides a speed reduction and torque increase from the output shaft 130 to the camshaft 140. The output shaft 130 is rotatably supported by a first or forward bearing 142, which is seated within the camshaft 140, and a second or rear bearing 144.

The drive assembly 122 of the impact tool 100 further includes an anvil 150 extending from the gear case 22 with a bit holder 152 to which a tool element (e.g., a screwdriver bit, a socket bit, etc.; not shown) can be coupled for performing work on a workpiece (e.g., a fastener). The anvil 150 is rotatably supported by a bearing 166 fixed within a front portion of the housing 102. The drive assembly 122 is configured to convert the continuous rotational force or torque provided by the motor 118 and gear assembly 120 to a striking rotational force or intermittent applications of torque to the anvil 150 when the reaction torque on the anvil 150 (e.g., due to engagement between the tool element and a fastener being worked upon) exceeds a certain threshold. In the illustrated embodiment of the impact tool 100, the drive assembly 120 includes the camshaft 140, a hammer 154 supported on and axially slidable relative to the camshaft 140, and the anvil 150.

With continued reference to FIG. 4, the drive assembly 122 further includes a spring 156 biasing the hammer 154 toward the front of the impact tool 100 (i.e., toward the right in FIG. 4). In other words, the spring 156 biases the hammer 154 in an axial direction toward the anvil 150, along the axis 114. A thrust bearing 158 and a thrust washer 160 are positioned between the spring 156 and the hammer 154. The thrust bearing 158 and the thrust washer 160 allow for the spring 156 and the camshaft 140 to continue to rotate relative to the hammer 154 after each impact strike when lugs on the hammer 154 engage with corresponding anvil lugs and rotation of the hammer 154 momentarily stops.

The camshaft 140 further includes cam grooves 162 in which corresponding cam balls 164 are received. The cam balls 164 are in driving engagement with the hammer 154 and movement of the cam balls 164 within the cam grooves 162 allows for relative axial movement of the hammer 154 along the camshaft 140 when the hammer lugs and the anvil lugs are engaged and the camshaft 140 continues to rotate.

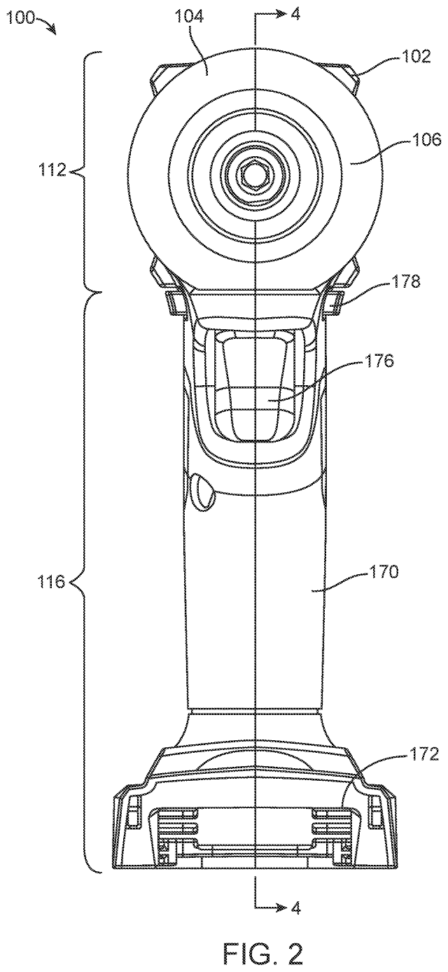

FIGS. 1-4 further show that the handle portion 116 of the impact tool 100 includes a grip 170. Further, the handle portion 116 includes a battery receptacle 172 that is configured to receive a removable battery pack to provide power to the motor 118. A circuit board 174 is disposed within the handle portion 116 and includes the electronics that control the operation of the impact tool 110 (FIG. 4). The handle portion 116 also includes a trigger 176 that is actuatable to selectively energize the motor 118. FIGS. 2 and 3 further show that the impact tool 100 includes a direction selector button 178 that extends laterally through the housing 102. The direction selector button 178 allows an operator of the impact tool 100 to change the direction of rotation of the output shaft 130.

Referring to FIG. 6-8 , details concerning the construction of the rotor and fan assembly 124 are illustrated. As shown, the rotor and fan assembly 124 includes a rotor 180. The rotor 180 includes a plurality of metal layers or laminations 182 that are laminated together. Further, the rotor and fan assembly 124 includes a fan 184 adjacent the rotor 180. In an embodiment, the fan 184 the fan is metal, plastic, ferromagnetic, or another suitable material, and the fan 184 is affixed to the rotor 180. For example, the fan 184 is affixed to the rotor 180 via one or more fasteners or an adhesive. In another aspect, the fan 184 is molded onto the rotor 180 and partially held in place via one or more channels 186, or veins, formed in the rotor 180 into which molten material comprising the fan 184 flows into during a molding process. Alternatively, the fan 184 is molded around one or more projections, e.g., magnet portions, that extend from a face of the rotor 180.

As shown in FIG. 6, the fan 184 includes a generally disc-shaped base plate 188 and a central hub 190 extends therefrom. The central hub 190 is affixed to the rotor 180 as described herein. The fan 184 further includes a plurality of vanes 192, or blades, that extend from the base plate 188 on the same side as the central hub 190 (i.e. toward the rotor 180) and radially outwardly from the central hub 190.

FIG. 6-8 further show that the rotor 180 is formed with a plurality of magnet pockets 200 that extend axially along a length of the rotor 180 and entirely through the length of the rotor 180 and perpendicularly through the plurality of metal layers 182. Each magnet pocket 200 is flanked by a first channel 202 and a second channel 204 that extend along the length of each magnet pocket 200 adjacent each side of the magnet pocket 200. A permanent magnet 206 is disposed within each magnet pocket 200.

Each magnet 206 includes an overlap portion 208 and each overlap portion 208 of each magnet 206 extends beyond the face of the rotor 180 adjacent the fan 184. (FIG. 8). The fan 184 is formed with a plurality of magnet pockets 210 that extend at least partially into the central hub 190. Each magnet pocket 210 is configured to receive the overlap portion 208 of a corresponding one of the magnets 206 partially disposed within the rotor 180. Further, each magnet pocket 210 includes a pocket length LP and the fan 184 defines a fan length LF. In this aspect, LP is greater than or equal to 0.10×LF, such as greater than or equal to 0.15×LF, greater than or equal to 0.20×LF, or greater than or equal to 0.25×LF. In another aspect, LP is less than or equal to 0.55×LF, such as less than or equal to 0.50×LF, less than or equal to 0.45×LF, less than or equal to 0.40×LF, less than or equal to 0.35×LF, or less than or equal to 0.30×LF. It is to be appreciated that LP may be within a range between, and including, any of the minimum and maximum values of LP described herein.

In a particular aspect, each magnet 206 defines a magnet length LM and the overlap portion 208 of each magnet 206 defines an overlap length LO. In one aspect, LO is equal to LP. Further, LO is greater than or equal to 0.05×LM, such as greater than or equal to 0.10×LM, greater than or equal to 0.15×LM, or greater than or equal to 0.20×LM. In another aspect, LO is less than or equal to 0.50×LM, such as less than or equal to 0.45×LM, less than or equal to 0.40×LM, less than or equal to 0.35×LM, less than or equal to 0.30×LM, or less than or equal to 0.25×LM. It is to be appreciated that LO may be within a range between, and including, any of the minimum and maximum values of LO described herein.

In another aspect, the rotor 180 defines a rotor length LR. In this aspect, LO is greater than or equal to 0.15×LR, such as greater than or equal to 0.20×LR, greater than or equal to 0.25×LR, or greater than or equal to 0.30×LR. In another aspect, LO is less than or equal to 0.60×LR, such as less than or equal to 0.55×LR, less than or equal to 0.50×LR, less than or equal to 0.45×LR, less than or equal to 0.40×LR, or less than or equal to 0.35×LR. It is to be appreciated that LO may be within a range between, and including, any of the minimum and maximum values of LO described herein.

In yet another aspect, LO is greater than or equal to 0.10×LF, such as greater than or equal to 0.15×LF, greater than or equal to 0.20×LF, or greater than or equal to 0.25×LF. In another aspect, LO is less than or equal to 0.55×LF, such as less than or equal to 0.50×LF, less than or equal to 0.45×LF, less than or equal to 0.40×LF, less than or equal to 0.35×LF, or less than or equal to 0.30×LF. It is to be appreciated that LO may be within a range between, and including, any of the minimum and maximum values of LO described herein.

In another aspect, the overlap portion 208 of each magnet 206 is press fit into the pockets 210 on the fan 184. In another aspect, the fan 184 is molded around the overlap portions 208 of the magnets 206. It is to be understood that embedding the overlap portion 208 of each magnet 206 within the fan 184 saves space. Alternatively, larger magnets can be used without increasing the size of the tool in which the rotor and fan assembly 124 is installed.

To operate the impact tool 100, an operator depresses the trigger 176 to activate the motor 118, which continuously drives the gear assembly 120 and the camshaft 140 via the output shaft 130. As the camshaft 140 rotates, the cam balls 164 drive the hammer 154 to co-rotate with the camshaft 140, and the hammer lugs engage, respectively, driven surfaces of the anvil lugs to provide an impact and to rotatably drive the anvil 150 and the tool element.

After each impact, the hammer 154 moves or slides rearward along the camshaft 140, away from the anvil 150, so that the hammer lugs disengage the anvil lugs. As the hammer 154 moves rearward, the cam balls 164 situated in the respective cam grooves 162 in the camshaft 140 move rearward in the cam grooves 162. The spring 156 stores some of the rearward energy of the hammer 154 to provide a return mechanism for the hammer 154. After the hammer lugs disengage the respective anvil lugs 220, the hammer continues to rotate and moves or slides forwardly, toward the anvil 150, as the spring 156 releases its stored energy, until the drive surfaces of the hammer lugs re-engage the driven surfaces of the anvil lugs to cause another impact.

The rotor and fan assembly 124 is shown incorporated in a rotary impact tool 100, but the rotor and fan assembly 124 may alternatively be used with other rotary power tools (e.g., drills, reciprocating saws, rotary hammers, pulse drivers, etc.) for supporting an output spindle or shaft. In such tools, the rotor and fan assembly 124 provides a more compact tool.

Although the invention has been described in detail with reference to certain preferred embodiments, variations and modifications exist within the scope and spirit of one or more independent aspects of the invention as described.

1. A power tool comprising:
a housing;
a motor supported within the housing, the motor including a stator and a rotor, the rotor including a plurality of permanent magnets; and
a fan coupled to the rotor for rotation therewith relative to the stator, the fan including a plurality of magnet pockets,
wherein each of the plurality of permanent magnets has an overlap portion extending beyond a face of the rotor and into a respective magnet pocket of the plurality of magnet pockets.

2. The power tool of claim 1, wherein the fan is made of a ferromagnetic material.

3. The power tool of claim 1, wherein the rotor includes a plurality of laminations.

4. The power tool of claim 3, wherein the plurality of laminations includes an end lamination defining the face of the rotor.

5. The power tool of claim 1, wherein the fan is molded around the overlap portions of the plurality of permanent magnets adjacent the fan.

6. The power tool of claim 1, wherein the fan is molded separately from the rotor and press fit over the overlap portions of the plurality of permanent magnets.

7. The power tool of claim 1, wherein the fan is affixed to the rotor via an adhesive.

8. The power tool of claim 1, wherein the fan is affixed to the rotor via a fastener.

9. A power tool comprising:
a housing;
a motor supported within the housing, the motor including a stator and a rotor, the rotor including a plurality of permanent magnets each having an overlap portion extending beyond a face of the rotor; and
a fan coupled to the rotor for rotation therewith relative to the stator, the fan including a disc-shaped base plate, a central hub extending therefrom, and a plurality of magnet pockets extending into the central hub, wherein each magnet pocket receives a respective overlap portion of each of the permanent magnets.

10. The power tool of claim 9, wherein each of the plurality of permanent magnets defines a magnet length LM and the overlap portion of each of the plurality of permanent magnets defines an overlap length LO and LO is greater than or equal to 0.05×LM.

11. The power tool of claim 9, wherein LO is less than or equal to 0.5×LM.

12. The power tool of claim 9, wherein the rotor defines a rotor length LR and the overlap portion defines an overlap length LO and LO is greater than or equal to 0.15×LR.

13. The power tool of claim 9, wherein LO is less than or equal to 0.6×LR.

14. The power tool of claim 9, wherein the fan defines a fan length LF, the overlap portion defines an overlap length LO, and LO is greater than or equal to 0.10×LF.

15. The power tool of claim 13, wherein LO is less than or equal to 0.55×LF.

16. A power tool comprising:
a housing;
a motor supported within the housing, the motor including a stator and a rotor, the rotor including a plurality of metal layers laminated together, a plurality of magnet pockets extending perpendicularly through the plurality of metal layers, and a permanent magnet disposed within each of the plurality of magnet pockets, wherein each permanent magnet includes an overlap portion that extends beyond a face of the rotor; and
a fan coupled to the rotor for rotation therewith relative to the stator, the fan including a plurality of magnet pockets and the overlap portion of each permanent magnet extends into one of the plurality of magnet pockets.

17. The power tool of claim 16, wherein the fan includes a base plate, a central hub extending from the base plate, a plurality of vanes extending from the base plate in a same direction as the central hub and radially outwardly from the central hub.

18. The power tool of claim 16, wherein each of the plurality of magnet pockets extends into the central hub toward the base plate.

19. The power tool of claim 16, further comprising a first channel extending along a length of each magnet pocket adjacent a first side of each magnet pocket.

20. The power tool of claim 19, further comprising a second channel extending along the length of each magnet pocket adjacent a second side of each magnet pocket.
